(19) United States
(12) Patent Application Publication
(10) Pub. No.: US 2003/0110497 A1
(43) Pub. Date: Jun. 12, 2003

(54) Micro-auction on television using multiple rewards to benefit the viewer of commercials

(75) Inventors: Amr F. Yassin, Ossining, NY (US); Yasser alSafadi, Yorktown Heights, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/014,239

(22) Filed: Dec. 11, 2001

(51) Int. Cl. H04N 7/16; G06F 3/00; H04N 5/445; G06F 13/00

(52) U.S. Cl. 725/42; 725/39; 725/23; 725/51

(57) ABSTRACT

The invention relates to a method of presenting a commercial in a time slot to a viewer. The method includes providing one or more commercials to a receiver operatively coupled with a display device, with commercial having an associated agent. The agent is configured to place a bid for the time slot on behalf of the associated commercial. The bid includes a reward component to be granted to the viewer if the associated commercial is selected. Further, a profile database is maintained to store data related to local viewer preferences, which may include preference data, including the units preferred by the viewer for the reward component of the bid. At least one commercial may access the local viewer preference related data in the profile database and the agent may use the accessed local viewer preference related data to determine the bid to be placed for the time slot. The time slot is then auctioned to the one or more commercials provided to the receiver and the commercial having the agent which placed the winning bid is selected to be displayed on the display device during the time slot. The viewer is then rewarded with the reward component of the winning bid, and this information is stored in a vault.

### FIELD OF THE INVENTION

The invention relates to a method and system for providing a micro-auction using multiple rewards to determine which of a selection of commercials will be presented to the television viewer during a given time slot for the benefit of the viewer of the commercial. Specifically, the present invention is directed to a method and system for awarding a commercial time spot to the commercial for which the greatest award, in the opinion of the viewer, is given to the viewer.

### BACKGROUND OF THE INVENTION

Television commercial advertisements and other similar promotional or broadcasting “spots”, hereinafter referred to as “commercials”, are currently prepared by an advertising agency or similar organization. The commercial is then inserted into the broadcast stream by a broadcaster of a program and presented to the viewer. Only a single commercial is assigned to each time slot on a given channel, so the actual television receiver and monitor present the single broadcast commercial to the viewer, without consideration of any local individual factors.

This process of bringing commercial advertisements to the viewer includes several limitations.

First, the viewer is only presented with the commercial that is broadcast. There is no input of criteria specific to the individual viewer. This limitation often leads to viewers who are not interested in the commercial or the products/services being advertised, which means that advertiser investment in purchasing the time slots is wasted.

Therefore, it would be beneficial to allow a variety of competing commercials to vie for a given time slot, and to provide more individualized criteria for selection of which commercial to award a given time slot to. This would serve to alleviate the problem of advertisers having to purchase an entire geographical area to reach a more limited group of potentially interested viewers.

Second, the broadcast station (or cable station, or Internet broadband channel, etc.) is the only source for commercials. Since the advent of television, the source of the broadcast program has always been the only source of the commercial advertising to be presented. This requires the broadcaster to find advertisers or other sponsors for the available time slots, and, additionally, limits the broadcaster to only one potential advertiser per time slot.

Thus, there is a benefit to allow commercials to originate from a source or sources other than the broadcast station. This would potentially allow the broadcaster to focus more on program content quality and less on finding advertisers for available time slots. Additionally, by providing more than one source from which to broadcast commercials for the same time slot, competition for commercial time slots could be increased—thus, potentially increasing revenues for program providers.

Third, conventionally there is a one to one relationship between the broadcast commercial and the presented commercial. This relationship has been a common practice for some time, but affords no flexibility at the viewer's end for customization of the commercial to be displayed. It often results in the viewer being presented with a commercial whose contents are of no interest to the viewer.

Therefore, there is a benefit to enable the broadcast of multiple commercials to be potentially viewed for a given commercial time slot. If a selection criteria additionally considers the viewer's habits when determining which of several commercials will be shown, the likelihood that a given viewer would be interested in the commercial selected for display would be enhanced.

Fourth, the identification and selection of the target audience of the commercial is conventionally determined by the broadcast station. Typically, the advertiser may select a program and a geographical region in which to show their commercial. This traditional method of selecting where and when a commercial is run does not offer the advertiser the ability to target individuals by criteria other than the program and the geographical location.

Thus, there is a desire for a method and system for selecting time slots and target audiences in which to run a commercial, so as to allow the advertiser to reach individuals using selection criteria other than the program selected for viewing and the geographical location of the viewer. As an example, it would be beneficial if the advertiser could know information regarding a viewer's program selection and viewing habits, then use this information to target viewers on an individual basis.

Fifth, the selection of the time slots for commercials by the advertiser is usually performed at the beginning of the viewing season. This is normally well in advance of the viewing experience. This advance scheduling of time slots has been a common practice for some time, but does not allow for factors that arise after the schedule is made to play any role in the decision of when and where to run an advertiser's commercial.

Therefore, there is a desire to provide an advertiser with the ability to select the time slot(s) to be purchased on a more dynamic basis, which may be weekly, daily, hourly, or even immediately prior to the time slot(s).

Sixth, the viewer does not generally benefit directly from the commercials he/she views, except for whatever benefit inures from the informational content of the commercial (i.e., “don't smoke”, etc.)

Thus, a desire exists for a method and system which would allow for a viewer to directly benefit from his/her viewing of a commercial. The present invention satisfies these needs.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

To achieve these and other advantages and in accordance with the purpose of the invention, as embodied and broadly described, the invention includes a method of presenting a commercial in a time slot to a viewer. The method includes providing one or more commercials to a receiver operatively coupled with a display device. Each commercial has an agent associated with it. The agent for each commercial is configured to place a bid for the time slot on behalf of the associated commercial. The bid includes a reward component to be granted to the viewer if the associated commercial is selected. The time slot is then auctioned to the one or more commercials provided to the receiver. The commercial having the agent which placed a winning bid is selected to be displayed on the display device during the time slot.

In another embodiment, a method of presenting a commercial in a time slot to a viewer is described. The method includes providing one or more commercials to a receiver operatively coupled with a display device, with commercial having an associated agent. The agent is configured to place a bid for the time slot on behalf of the associated commercial. The bid includes a reward component to be granted to the viewer if the associated commercial is selected. Further, a profile database is maintained to store data related to local viewer preferences, which may include preference data, including the units preferred by the viewer for the reward component of the bid. At least one commercial may access the local viewer preference related data in the profile database and the agent may use the accessed local viewer preference related data to determine the bid to be placed for the time slot. The time slot is then auctioned to the one or more commercials provided to the receiver and the commercial having the agent which placed the winning bid is selected to be displayed on the display device during the time slot. The viewer is then rewarded with the reward component of the winning bid, and this information is stored in a vault.

The invention also includes a system for presenting a commercial in a time slot to a viewer. The system includes at least one source of one or more commercials. Each provided commercial has an agent associated with it. The agent for each commercial is configured to place a bid for the time slot on behalf of the associated commercial. The bid includes a reward component to be granted to the viewer if the associated commercial is selected. The system includes a receiver operatively coupled with a display device. The receiver configured to receive each commercial and associated agent. A processor operatively coupled with the receiver and capable of executing instructions encoded by the agent associated with each commercial is configured to determine the bid to be placed for the time slot. The time slot is auctioned to the one or more commercials provided to the receiver. The commercial having the agent which placed a winning bid is selected and displayed on the display device during the time slot.

It is understood that both the foregoing general description and the following detailed description are exemplary and are intended to provide further explanation of the invention claimed.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF DRAWINGS

FIG. 1 is a schematic representation of a system for broadcasting of a program and one or more commercials to compete for one or more time slots, and performing a time slot auction in accordance with a preferred embodiment of the current invention;

FIG. 2 is a flowchart of an auction process in accordance with a preferred embodiment of the current invention; and

FIG. 3 is a detailed flowchart of a representative auction involving multiple bidders in accordance with a preferred embodiment of the current invention;

### DETAILED DESCRIPTION OF THE PREFERRED EMBODIMENTS

The following description is presented to enable any person of ordinary skill in the art to make and use the present invention. Various modifications to the preferred embodiment will be readily apparent to those of ordinary skill in the art, and the disclosure set forth herein may be applicable to other embodiments and applications without departing from the spirit and scope of the present invention and the claims hereto appended. Thus, the present invention is not intended to be limited to the embodiments described, but is to be accorded the broadest scope consistent with the disclosure set forth herein.

In accordance with a preferred embodiment of the invention, a system is provided to broadcast more than one commercial and enable competition for a single commercial time slot on a single channel. The individual commercials may be broadcast by any of several methods, including by standard television signal, by cable, or over the Internet. Each commercial may be broadcast at the same or nearly the same time as the program being viewed, or each commercial may be pre-loaded to the viewing device in advance via a prior broadcast if desired and appropriately structured. Also, each commercial has an associated agent which is responsible for the formulation of an actual bid price for the auctioned time slot. The agent may be as simple as a fixed bid price, or may be a more complex computer software applet. An agent software applet would include an algorithm capable of calculating or determining a desired bid. The agent may be broadcast with the commercial, or it may be sent by a separate route and later associated with the commercial. For example, a commercial sent over the Internet would preferably be coupled with and accompanied by its agent. If the same commercial were sent over a standard broadcast transmitter, the agent would preferably be sent by a more loss-less method, such as the Internet, and coupled with the commercial at the receiver. Although not preferred, the agent could be broadcast coupled with the commercial as well.

Advantageously, the ability to broadcast multiple commercials and to hold an auction to determine which of the broadcast commercials ultimately is presented at the desired time slot separates the broadcasting of commercials from the actual presentation of commercials. This ability also advantageously allows for different sources for the program to be viewed and the commercials to be presented during commercial time slots. Thus, a program provider or broadcast channel administrator is no longer required to provide the commercials to run in these time slots. Of course, the broadcast channel administrator or program provider may still provide one, several, or no commercials, while still being able to gain from the revenue generated by the auction of the time slots.

Another advantage of the current invention is the competition generated between multiple commercials vying for a single commercial time slot. Particularly, the present invention allows advertisers or sponsors to selectively focus their funds and efforts on actually presenting commercials to a targeted audience, rather than needing to purchase saturation coverage of particular time slots to reach the same desired audience.

The present invention also is advantageous in that the target audience may be selected at the television set, rather than by the broadcaster, and that the auction can be run at any time, such as weekly, daily, hourly, or on a just-in-time basis. Local selection of the target audience allows, as an example, the commercial agent to identify a desired or predetermined trait from a profile database maintained locally, and to set the auction bid price from such information. To illustrate, a particular viewer may have actively identified himself as an elderly male, and allowed this information to be stored in a profile database. An advertiser of supplement medicare insurance may therefore choose to increase its bid for a commercial timeslot whenever this viewer is determined to be watching his television. Alternatively, information used by the agent for setting the auction bidding price may be covertly gathered into a profile database. For example, the television receiver may store a viewer's programming habits into a profile database. Illustratively, it may store the fact that a given viewer usually watches mystery movies (wherein information on program content may be provided online, such as electronic program guides, or by other methods, many of which are well known in the art). An advertiser of mystery novels may then use this information to determine to increase its bid price for an advertising time slot for this viewer.

Further, in accordance with the present invention, the bid by the agent can include an award component to be granted to the viewer if the associated commercial is selected in this manner. Another advantage of the current invention is that a time slot generally can be awarded to the commercial that values the particular viewer and/or time slot most. Thus, revenue for advertising time slots will be based more closely on the maximum commercial value to an advertiser and the viewer.

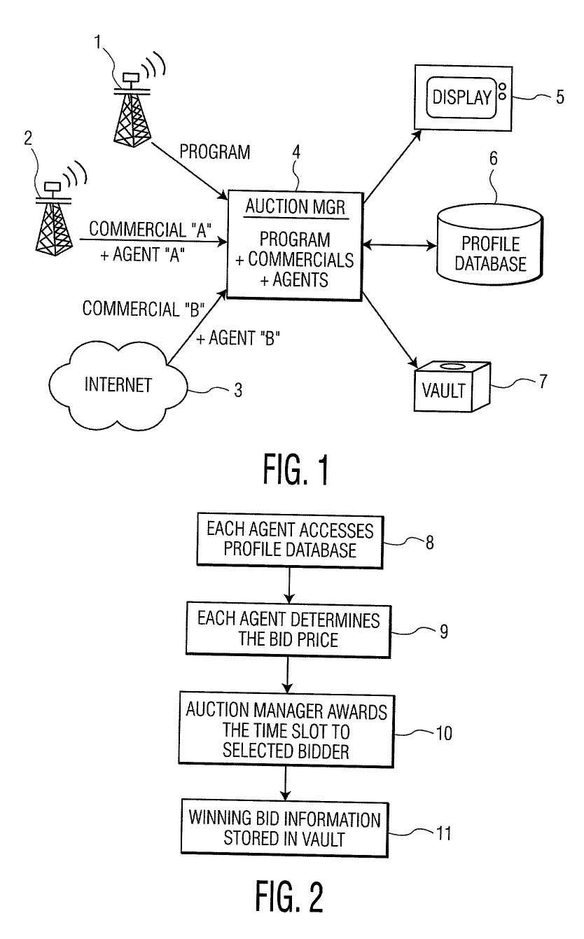

FIG. 1 is a schematic depiction of a system for broadcasting a program and one or more commercials to compete for one or more time slots, as well as a time slot auction, in accordance with a preferred embodiment of the current invention. A program is broadcast 1 by any of several methods. For example, a program broadcast 1 may be over the airwaves, such a standard television broadcast. It may also be broadcast, for example, over a cable or satellite network, or even over the Internet. These and other equivalent methodologies for broadcasting are well known in the art. The program broadcast 1, whatever its form, is received by a receiver 4. The receiver 4 may be coupled intrinsically or extrinsically to a display unit 5. The receiver 4 and display unit 5 may form one physical unit, such as is often the case with many known television sets. Another possibility is that the receiver 4 is mounted in a box attached to a common television set. Alternatively, the receiver 4 itself is further attached to a satellite dish antenna or to a computer unit with an Internet 3 connection.

The receiver embodied herein 4 has access to a profile database 6, which itself may be local or remote, and is used to store information about the viewers of the associated television, their viewing habits and award preference. For example, a profile database 6 may maintain information for each viewer of the display device, and include information on his/her viewing habits, such as programs viewed, viewing times, etc. Each viewer may be identified by their inputting identification information when he/she commence viewing, or less intrusively, by his/her use of personalized remote control equipment, or by other well-known means. Also, the profile database 6 could operate without personal viewer information and unobtrusively maintain only records of which programs were viewed, when they were viewed, etc. Importantly, the profile database 6 also would enable the viewer to select what types of rewards he/she values most. For example, one viewer might prefer getting frequent flyer miles, while another prefers receiving cash. A viewer who does not select a preferred reward type would default to a reasonable reward type, such as cash.

The receiver 4 may optionally operate in conjunction with a vault 7. The purpose of the vault is to provide for storage of information about the outcome of each auction. The vault may be implemented as a component within the receiver 4 itself, or may be a separate and distinct unit. A vault may support multiple viewers. It can store the different categories of the auction outputs. The rewards stored in the vaults may be uploaded to the viewer or others and may be used by the viewer. For example, if the output of an auction is free calling minutes, the minutes may be stored in the vault and later uploaded to the telephone system and used for calling.

In operation, the receiver 4 will receive program content broadcast as described above. The receiver will also be provided or receive one or more commercials and associated agents by similar or alternative broadcast means 2, or even over the Internet 3. The commercials and their agents may be broadcast at or near the same time as the broadcast of the program, or may be broadcast prior to the program and stored at the receiver or a storage device associated with the receiver. Some commercials may be broadcast using one broadcast method, such as the method used for broadcast of the associated program, while others may use a broadcast method different from that of the program broadcast. Also, it is within the scope of this invention that agents may be sent by a different method and at a different time than their associated commercials. This situation might occur, for example, when a commercial is broadcast by a transmission antenna in standard television format, which includes the risk of signal loss and static interference. It therefore might be more desirable for an agent that consists of a complex set of computer instructions to be broadcast over a loss-less connection, such as an Internet connection, and mated with its associated commercial at the receiver 4.

An agent includes the information and/or algorithm for setting the auction bid price for a given commercial time spot. In accordance with the invention, the bid provided by the agent for the time slot includes an award component to be granted to the viewer if the associated commercial is selected. A fixed or variable monetary component to be paid to the program broadcaster also may form part of the bid. The information associated with an agent may be as simple as a fixed price for bidding, or as complex as an applet which, when invoked, gathers input information from the profile database, the vault, a system clock, an electronic programming guide, or elsewhere, and uses the gathered information to reach a decision as to the auction bid price and units for the time spot. The agent then conveys its bid to an auction manager, which would preferably reside on the receiver 4. The auction manager may include any appropriate software, hardware or combination thereof as is known. The auction manager collects all bids, enables the commercial with the winning bid to be viewed on the display 5, and update the vault 7, if provided, with the successful bid information. It is also possible that the profile database 6 may be updated at this time to reflect that the commercial was viewed.

Several different bid formats may be employed. The most common auction is known as the “English” auction, whereby the highest bidder wins. Another type of auction that can be employed with the present invention is the “Vikrey” auction, whereby the winner is the bidder with the second-highest bid. Yet another auction type that may be used with the present invention is the “Dutch” auction. In the Dutch auction, the bid price is first set at a relatively high level by the auction manager. The bid price is lowered in intervals until a bidder accepts the price, at which time the auction ends with the bidder winning. Other known or suitable auction formats likewise may be employed as desired.

The vault 7, if provided, stores information on the successful bids, the commercials shown, their bid price (and units), etc. This information can then be gathered from the vault 7 and used to debit the entities whose commercials were viewed and to credit the viewer, either by a direct deposit transaction, such as would be used if frequent flyer miles are the reward of the viewer's preference. This information gathering may be over a secure Internet connection (not depicted) or by other means well known in the art. If no vault is provided, debiting and crediting for the viewed commercials can be provided by other means. For example, the information of what commercial was presented and the winning bid price and unit may be sent over the Internet or another communications network. Similarly, this information may be stored locally at the receiver and gathered by a debiting/crediting authority on a regular basis. Other methods of saving and gathering bid information are generally known.

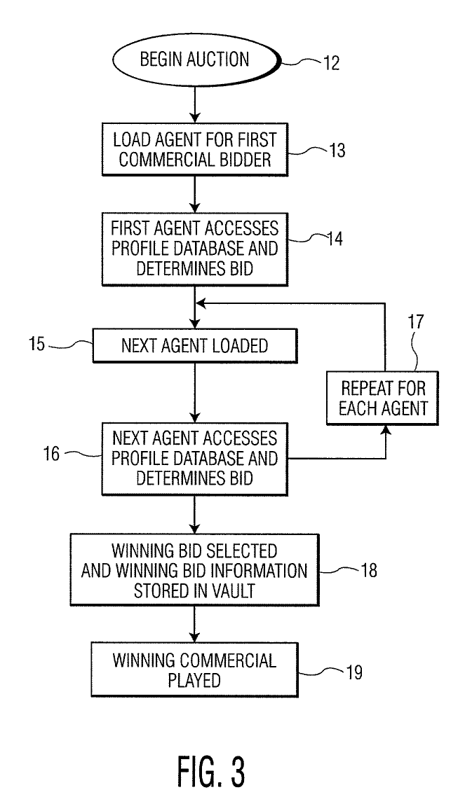

FIG. 2 is a flowchart of the general process of an auction in accordance with the present invention. A commercial's agent preferably is configured to access a profile database 8 and gather information about the viewer and/or his/her viewing habits. For example, the agent might inquire if the viewer is male or female, the viewer's age, favorite type of television show, whether the commercial has been viewed previously, and other information.

Using this collected information, the agent is configured to determine and generate a price to bid 9 for the commercial time slot available. This determination may be as simple as bidding a fixed price, or it may be algorithmically complex, or any level of sophistication in between. As an example, if the program is a cooking show, an agent for a food seasoning commercial may set a high bid price, particularly if the profile database indicates that the viewer often watches cooking programs. Similarly, the agent might set a low bid price, or even none at all, if the profile database indicates the viewer belongs to a non-preferred demographic group for the purchase of food seasoning. Generally, this process is performed for each broadcast commercial associated with the commercial time slot.

Based upon the bids generated, the auction manager awards the time slot to the highest bidder 10, unless otherwise programmed, and stores the winning bid information in the vault 11.

Notably and in accordance with the present invention, it is possible for the agents to bid in different units. For example, one agent may offer ten cents a minute for viewers of its commercial while another agent offers twenty frequent flyer miles per minute. The viewer's profile database would then be queried by the auction manager to determine what units are preferred. In this example, if cash is preferred the ten cents per minute wins over the twenty miles per minute. If the viewer has no personal unit preference, a suitable default, such as preferring cash over mileage is set as a default. Any units could also be used as a default preference. Moreover the viewer can set an ordered list of preferred units, such as “cash over miles over calling card minutes over points towards movie tickets . . . ”.

FIG. 3 is a flowchart of a more detailed description of the auction of an embodiment of the present invention. The auction of this embodiment begins 12 prior to the start time of the time slot to be auctioned. The auction could actually be held any time prior to the time slot being auctioned, although it is preferable to have the auction as near to the beginning of the time slot as possible, so long as sufficient time remains to allow seamless viewing of the commercial awarded the time slot. The later the auction, and thus closer to the start time of the time slot, the more updated the information potentially available to the commercial agents and on which the agents may base the bid price.

In detail, the auction manager, which preferably resides at the receiver, but may be a separate component, would load and execute the first commercial agent 13. As previously noted, the agent may be as simple as a fixed bid price (a “trivial” agent) or it may be a complex algorithm.

If the agent is not trivial (i.e., not a fixed bid price), the agent accesses the profile database and use the information therein to determine the bid price and units for the time slot being auctioned 14. Furthermore, the information used by the agent to determine the bid price is not limited to the information retrieved from the profile database, but may include numerous other information sources. As examples but not limitations, the agent may access an online programming guide to determine the type of program being viewed by the viewer. Similarly, the agent might consult a real-time clock maintained by the auction manager, or a global positioning system to determine geographic location, or information stored in the vault to determine if the commercial has been previously viewed by the viewer, or any combination of these and other information sources. Another possible information source is the auction manager itself. The agent's bid is then provided to the auction manager. The auction manager would preferably, although not necessarily, be configured to provide each competing agent with the amounts bid thus far.

The auction manager then, or simultaneously, loads the next commercial's agent 15. If there is only one bidding commercial agent, this step is skipped. Otherwise, the newly-loaded agent accesses the profile database (and other information sources if desired or appropriate) and determines the bid for the time slot 16, passing this to the auction manager, as above.

The auction manager repeats 17 the steps of loading each agent 15, and each agent determines the bid price and unit for the time slot 16.

When each commercial agent has determined its bid price for the available time slot, the auction manager will again poll each agent to determine if any elect to increase their bid in response to the bids of the other agents. This process would preferably repeat until no agent increases its bid. The auction manager then selects the winning bid and stores the winner's identification information and bid price and unit in the vault 18. The vault can be used at any subsequent time to determine how much in what units has been bid by which advertisers, and hence, how many points/rewards are owed by the advertiser to the viewer. Alternatively, the commercial awarded the time slot and the final bid price can be transmitted to a debit/credit authority at the time of selection if no vault is provided.

Finally, the commercial whose agent placed the winning bid is played during the time slot 19.

It will be apparent to those skilled in the art that various modifications and variations can be made in the method and system of the present invention without departing from the spirit and scope of the invention. Thus, it is intended that the present invention include modifications and variations that are within the scope of the appended claims and their equivalents.

What is claimed is:

1. A method of presenting a commercial in a time slot to a viewer, the method comprising the steps of:
providing one or more commercials to a receiver operatively coupled with a display device, each commercial having an agent associated therewith, the agent for each commercial configured to place a bid for the time slot on behalf of the associated commercial, the bid including a reward component to be granted to the viewer if the associated commercial is selected;
auctioning the time slot to the one or more commercials provided to the receiver;
selecting the commercial having the agent which placed a winning bid; and
displaying the selected commercial on the display device during the time slot.

2. The method of claim 1, further comprising the step of:
rewarding the viewer with the reward component of the winning bid.

3. The method of claim 1, further comprising the step of:
storing information related to the commercial having the agent which placed the winning bid in a vault.

4. The method of claim 3, further comprising the step of:
allowing the agent for at least one commercial to access information previously stored in the vault, the agent using the accessed information to determine the bid to be placed for the time slot.

5. The method of claim 1, further comprising the steps of:
maintaining a profile database to store data related to local viewer preferences; and
allowing the agent for at least one commercial to access the local viewer preference related data in the profile database, the agent using the accessed local viewer preference related data to determine the bid to be placed for the time slot.

6. The method of claim 5, wherein the local viewer preference related data maintained by the maintaining step identifies units preferred by the viewer for the reward component, and the agent determines the units for the reward component of the bid to be placed based upon the viewer preference related data.

7. The method of claim 1, wherein the bid placed by the agent of at least one commercial is a fixed amount.

8. The method of claim 1, wherein the winning bid is chosen as the bid having the highest value in units preferred by the viewer.

9. The method of claim 1, wherein the winning bid selected by the selecting step is determined by setting a desired value in units preferred by the viewer, and then reducing the desired value until the agent of at least one commercial places a bid at least equal to the desired value.

10. The method of claim 1, wherein the providing step includes loading at least one commercial and the agent associated therewith onto the receiver prior to the time slot.

11. A system for presenting a commercial in a time slot to a viewer, said system comprising:
at least one source of one or more commercials, the source providing each said commercial having an agent associated therewith, the agent for each commercial configured to place a bid for the time slot on behalf of the associated commercial, the bid including a reward component to be granted to the viewer if the associated commercial is selected;
a receiver operatively coupled with a display device, said receiver configured to receive each commercial and associated agent; and
a processor operatively coupled with the receiver, the processor capable of
executing instructions encoded by the agent associated with each commercial to determine the bid to be placed for the time slot;
auctioning the time slot to the one or more commercials provided to the receiver;
selecting the commercial having the agent which placed a winning bid; and
displaying the selected commercial on the display device during the time slot.

12. The system of claim 11, wherein the processor is further capable of rewarding the viewer with the reward component of the winning bid.

13. The system of claim 11, further comprising:
a vault operatively coupled with the processor for storing information related to the commercial having the agent which placed the winning bid.

14. The system of claim 13, wherein the processor is further capable of allowing each agent for at least one commercial to access information previously stored in the vault, the agent using the accessed information to determine the bid to be placed for the time slot.

15. The system of claim 11, further comprising:
a profile database operatively coupled with the processor to store data related to local viewer preferences; and
further wherein the processor is capable of allowing the agent for at least one commercial to access the local viewer preference related data in the profile database, the agent using the accessed local viewer preference related data to determine the bid to be placed for the time slot.

16. The system of claim 15, wherein the local viewer preference related data maintained by the maintaining step identifies units preferred by the viewer for the reward component, and the agent determines the units for the reward component of the bid to be placed based upon the viewer preference related data.

17. The system of claim 11, further comprising:
memory operatively coupled with the receiver, the source providing at least one commercial and the agent associated therewith onto the memory prior to the time slot.

18. A method of presenting a commercial in a time slot to a viewer, the method comprising the steps of:
providing one or more commercials to a receiver operatively coupled with a display device, each commercial having an agent associated therewith, the agent for each commercial configured to place a bid for the time slot on behalf of the associated commercial, the bid including a reward component to be granted to the viewer if the associated commercial is selected;
maintaining a profile database to store data related to local viewer preferences, the local viewer preference related data including units preferred by the viewer for the reward component;
allowing the agent for at least one commercial to access the local viewer preference related data in the profile database, the agent using the accessed local viewer preference related data to determine the bid to be placed for the time slot;
auctioning the time slot to the one or more commercials provided to the receiver;
selecting the commercial having the agent which placed a winning bid;
displaying the selected commercial on the display device during the time slot;
rewarding the viewer with the reward component of the winning bid; and
storing information related to the commercial having the agent which placed the winning bid in a vault.
